(19) United States
(12) Patent Application Publication
(10) Pub. No.: US 2025/0083540 A1
(43) Pub. Date: Mar. 13, 2025

(54) DEVICE FOR CONTROLLING FAST CHARGER TO REDUCE CIRCULATING CURRENT

(71) Applicant: UIF (University Industry Foundation), Yonsei University, Seoul (KR)

(72) Inventors: Jung-Wook PARK, Seoul (KR); Issac KIM, Seoul (KR)

(21) Appl. No.: 18/825,100

(22) Filed: Sep. 5, 2024

(30) Foreign Application Priority Data
Sep. 12, 2023 (KR) 10-2023-0121209

(51) Int. Cl. B60L 53/10; B60L 53/62

(52) U.S. Cl. CPC B60L 53/11; B60L 53/62; B60L 2210/10; B60L 2210/30

(57) ABSTRACT

Proposed is a charger control device, to which a circulating current reduction control technique is applied, for a parallel CLLC converter module for an electric vehicle charger. The charger control device according to an exemplary embodiment includes a first PI controller receiving an input related to a voltage, a second PI controller receiving an input related to a current, a first operator calculating a result value of the first PI controller and a result value of the second PI controller, a PSM controller outputting a switch operation signal according to a PSM control based on the result value of the first operator, and a PFM controller outputting a switch operation signal according to a PFM control based on the result value of the first operator.

### STATEMENT REGARDING GOVERNMENT SPONSORED RESEARCH OR DEVELOPMENT

The present disclosure was developed in the task of a project (Project identification number: 1711181682, Project number: 2020R1A3B2079407, Ministry name: Ministry of Science and ICT, Project management organization name: Korea Research Foundation of Korea, Research project name: Individual Basic Research (Ministry of Science and Technology), Research Project Name: Energy Transition Power Grid Research Group, Contribution rate: 1/1, Project implementation organization name: Yonsei University, Research period: 2023.03.01˜2024.02.29.)

Meanwhile, in all the aspects of the inventive concept, there is no property interest in the government of the Republic of Korea.

### CROSS REFERENCE TO RELATED APPLICATION

This application claims priority under 35 U.S.C. § 119 to Korean Patent Application No. 10-2023-0121209 filed on Sep. 12, 2023, in the Korean Intellectual Property Office, the disclosures of which are incorporated by reference herein in their entireties.

### BACKGROUND

### Technical Field

The present disclosure relates to a charger control device and, more particularly, to a control device, to which a circulating current reduction control technique is applied, for a parallel CLLC converter module for an electric vehicle charger.

### Description of the Related Art

Electric vehicle chargers should output power of up to hundreds of kW to meet the specifications of connectors such as CCS Combo 1, CCS Combo 2, CHAdeMo, GB/T, and Tesla superchargers. In addition, electric vehicle chargers should perform operations at high switching frequencies in order to reduce the volume of the charger and ensure high efficiency.

Electric vehicle batteries are currently increasing from 400V to 800V in consideration of the power density and efficiency of the power conversion system inside the electric vehicle. However, IGBT, MOSFET, SiC MOSFET, or GaN elements currently being developed have difficulty in performing operations of a fast charger with a single converter module on account of each of its own characteristics. Accordingly, operations of a charger is performed through a parallel CLLC converter structure in which individual converter modules are connected in parallel in accordance with the power specifications of the charger.

However, it is difficult to manufacture parameters of real elements to be exactly the same, and parameter values change depending on the aging of circuits, the operating conditions and the like. In addition, there exist errors in the switching signal entering the switch on account of delays in communication. This results in circulating currents that indicate a difference in the output current between each individual converter module.

Circulating currents cause individual converter modules to output power higher than the design specifications, thereby causing high current stress, and thus seriously reducing performance such as reliability, safety, and efficiency of circuits. Accordingly, there is a need for a control method capable of reducing circulating currents.

### SUMMARY

One task of the present disclosure relates to a control device to which a charger control method capable of reducing circulating currents is applied.

The charger control device according to an exemplary embodiment includes a first PI controller receiving an input related to a voltage, a second PI controller receiving an input related to a current, a first operator calculating a result value of the first PI controller and a result value of the second PI controller, a PSM controller outputting a switch operation signal according to a PSM control based on the result value of the first operator, and a PFM controller outputting a switch operation signal according to a PFM control based on the result value of the first operator.

Herein, a voltage operator outputting the input related to the voltage may be further included, wherein the voltage operator may calculate a difference between a reference voltage and an output voltage.

Herein, a current operator outputting the input related to the current may be further included, wherein the current operator may calculate a difference between a reference current and an output current. Herein, the first PI controller may be connected to a multiplier may receive K times the input related to the voltage from the multiplier, or the second PI controller may be connected to the multiplier and receive K times the input related to the current, wherein K may be a value between 0 and 1.

Herein, a third PI controller receiving the result value of the first operator may be further included, wherein the PFM controller may perform the PFM control by using the result value of the first operator as an input, and the PSM controller may perform the PSM control by using a result value of the third PI controller as an input.

Herein, the PSM controller and the PFM controller may output an operation signal of at least one switch included in a primary-side circuit of a converter module.

A charging device according to an exemplary embodiment includes at least one parallel module including an AC/DC converter module and a DC/DC converter module, and a control device controlling the at least one parallel module, wherein the control device includes a first PI controller receiving an input related to a voltage, a second PI controller receiving an input related to a current, a first operator calculating a result value of the first PI controller and a result value of the second PI controller, a PSM controller outputting a switch operation signal according to a PSM control based on the result value of the first operator, and a PFM controller outputting a switch operation signal according to a PFM control based on the result value of the first operator.

Herein, the PSM controller and the PFM controller may output an operation signal of at least one switch included in a primary-side circuit of the DC/DC converter module.

A charger control method which is performed in at least one processor according to an exemplary embodiment includes calculating an input related to a voltage by using a difference between a reference voltage and an output voltage, calculating an input related to a current by using a difference between a reference current and an output current, inputting the input related to the voltage into a first PI controller as well as inputting the input related to the current to a second PI controller, calculating a PI control result value by using a result value of the first PI controller and a result value of the second PI controller, and outputting a PSM control or a switch operation signal according to the PSM control based on the PI control result value.

Herein, a computer program being recorded on a computer-readable recording medium may be provided in order to execute the charger control method.

According to an exemplary embodiment of the present disclosure, a control device, to which a charger control method capable of reducing circulating currents is applied, may be provided.

### BRIEF DESCRIPTION OF THE DRAWINGS

FIG. 1 is a view for explaining a structure of an existing charger.

FIG. 2 is a view for explaining a structure of a recent charger.

FIG. 3 is an exemplary view for explaining a structure of a charger.

FIG. 4 is an exemplary view for explaining a parallel structure of a charger.

FIG. 5 is a graph showing an output waveform of each converter module in a conventional control device.

FIG. 6 is a view for explaining a conventional CLLC control device for a charger.

FIG. 7 is a view for explaining a charging device for reducing circulating currents according to an exemplary embodiment.

FIG. 8 is a graph showing an output waveform of each converter module in a control device according to an exemplary embodiment.

FIG. 9 is a view for explaining a charging device for reducing circulating currents according to another exemplary embodiment.

FIG. 10 is a graph showing an output waveform of each converter module in a control device according to another exemplary embodiment.

FIG. 11 is a view showing a flowchart of a charger control method according to an exemplary embodiment.

### DETAILED DESCRIPTION OF EXEMPLARY EMBODIMENTS

Since the exemplary embodiments described in the present specification are intended to clearly explain the idea of the present disclosure to those skilled in the art to which the present disclosure pertains, the present disclosure is not limited to the exemplary embodiments described in the present specification, and the scope of the present disclosure should be construed to include modifications or variations that do not depart from the ideas of the present disclosure.

The terms used in the present specification are selected as general terms currently widely used as possible in consideration of the functions of the present disclosure, but this may vary depending on the intentions of those skilled in the art to which the present disclosure pertains, precedents, or the emergence of new technologies. However, unlike this, when a specific term is defined and used in an arbitrary meaning, the meaning of the term will be described separately. Therefore, the terms used in the present specification should be interpreted based on the practical meaning of the term and the overall contents of the present specification, not simply the name of the term.

The drawings attached to the present specification are intended to facilitate the explanation of the present disclosure, and the shapes depicted in the drawings may be exaggerated and displayed as necessary to help the understanding of the present disclosure, so the present disclosure is not limited by the drawings.

When it is deemed that a detailed description of the construction or function of the disclosure related to the present disclosure in the present specification would obscure the gist of the present disclosure, a detailed description thereof will be omitted as necessary.

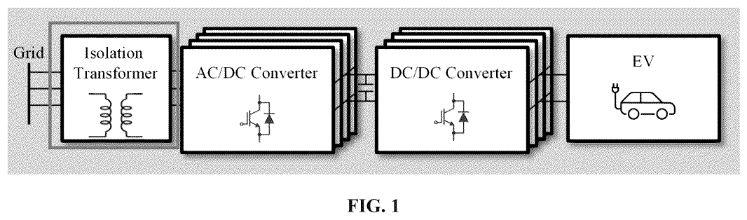

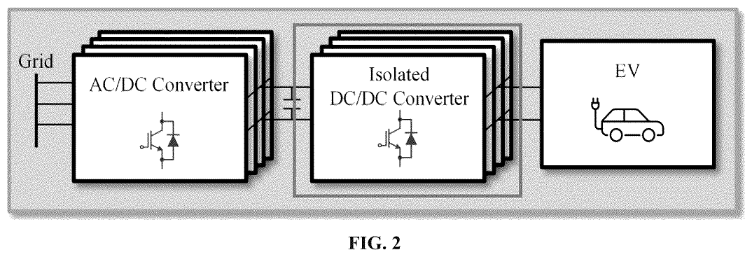

FIG. 1 is a view for explaining a structure of an existing charger. FIG. 2 is a view for explaining a structure of a recent charger.

Referring to FIGS. 1 and 2, a structure of an electric vehicle charger may be identified. Specifically, some components of the electric vehicle charger may correct the power factor of power from the grid through a power factor correction circuit (AC/DC PFC Converter). Thereafter, based on the output voltage of this circuit, the DC/DC converter may perform an operation of charging in various modes such as a constant current (CC), a constant power (CP), and a constant voltage (CV) in consideration of the SOC of an electric vehicle battery. In addition, the charger may have to perform galvanic isolation since connecting the grid and the electric vehicle battery, which may be performed in a grid transformer as shown in FIG. 1 or an isolated DC/DC converter as shown in FIG. 2.

Electric vehicle chargers may have the characteristic of having to output power of up to hundreds of kW to meet the specifications of connectors such as CCS Combo 1, CCS Combo 2, CHAdeMo, GB/T, and Tesla supercharger and the like. In order to reduce the volume of the charger, electric vehicle chargers should perform operations at high switching frequencies and ensure high efficiency. In addition, electric vehicle batteries may be currently increasing from 400V to 800V in consideration of the power density and efficiency of the power conversion system inside the electric vehicle. However, IGBT, MOSFET, SiC MOSFET, or GaN elements currently being developed may have difficulty in performing operations of a fast charger with a single converter module on account of the following characteristics.

First, IGBTs may have a wide range of switches with high voltage/current ratings, but may have disadvantages in terms of losses, including switching losses. MOSFETs may have disadvantages in terms of the lack and loss of switches with high voltage/current ratings. SiC MOSFET may have an advantage in terms of losses, but may lack switches with high voltage/current ratings. GaN may have an advantage in terms of losses, but switches with high voltage/current ratings may be severely lacking.

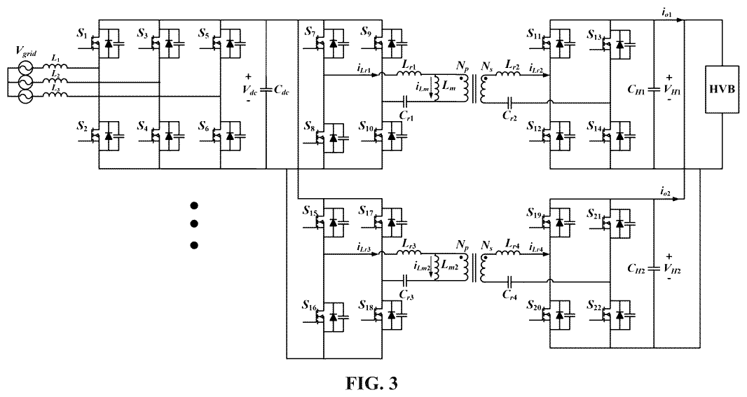

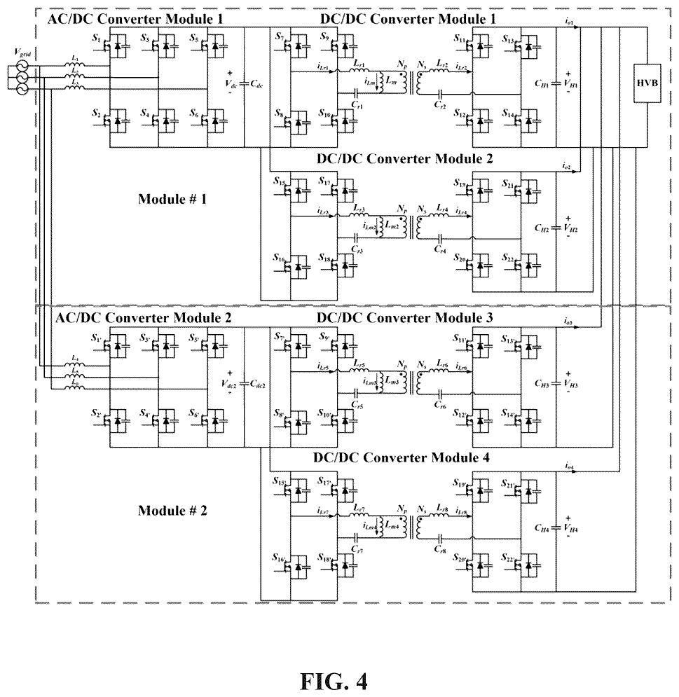

IGBT switches may be currently suitable to perform a high voltage/current operation of a charger, but the efficiency may be reduced due to a high loss. In order to ensure high efficiency, a SiC MOSFET and a GaN switch may be suitable, but there may be a problem of being difficult to perform the high voltage/current operation of the charger. Accordingly, the operations of the charger may be performed through a parallel CLLC converter structure (FIG. 4) in which individual converter modules included in the charger of FIG. 3 are connected in parallel in accordance with the power specifications of the charger.

Ideally, the parameter values of all the elements of each individual converter module constituting the parallel CLLC converter of FIG. 4 may be the same. In addition, the timing of the switching signals entering the switch may be exactly the same.

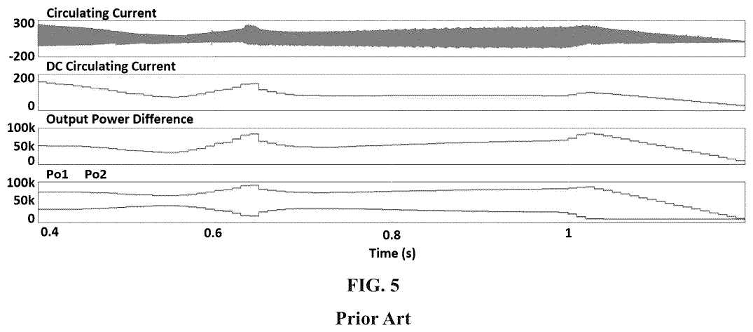

However, it may be practically difficult to manufacture parameters of elements to be exactly the same, and the parameter values may change depending on the aging of the circuit, the operating conditions and the like. In addition, there may exist errors in the switching signals entering the switch on account of delays in communication. This may result in circulating currents that indicate the difference in the output current between each individual converter module. The occurrence of circulating currents will be described below with reference to FIG. 5.

FIG. 5 is a graph showing an output waveform of each converter module in a conventional control device.

Referring to FIG. 5, it may be identified that circulating currents, which are the difference in the output current between each individual converter module, occur in a conventional control device. The circulating currents may cause differences in output power between individual converter modules, resulting in individual converter modules to output power higher than the design specifications. This may in turn cause high current stress, and thus seriously reduce performance such as reliability, safety, and efficiency of the circuit.

The electric vehicle battery may have a wide range of voltage characteristics ranging from 300 to 1000V based on 800V batteries according to SOC. To solve this, the CLLC resonant converter may operate through a hybrid control technique using not only a pulse-frequency modulation (PFM) control method that adjusts the operation switching frequency, but also a phase-shift modulation (PSM) control method. On account of this, circulating currents may occur in the parallel CLLC converter for electric vehicle chargers not only on account of the errors between element parameters and the switching signal errors, but also on account of the control instability in the transient section where the control technique is switched and the differences in control speed between individual converter modules.

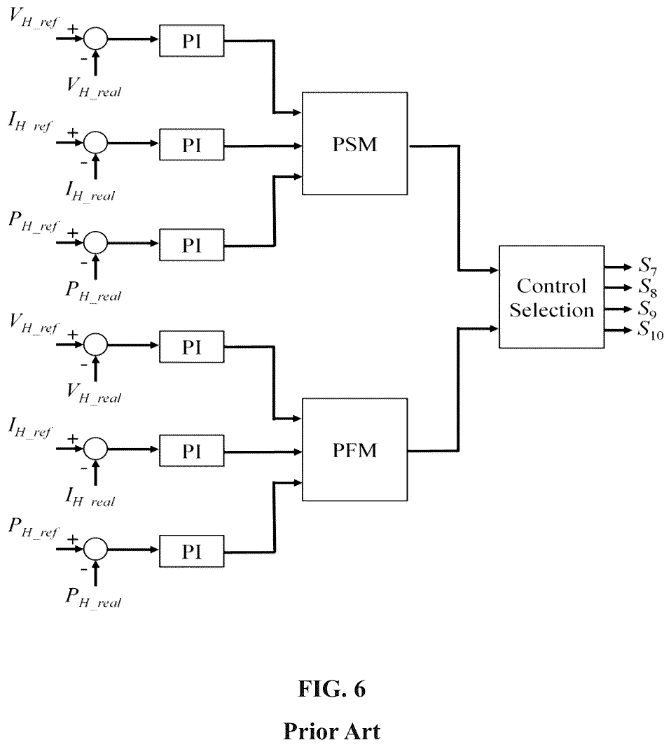

FIG. 6 is a view for explaining a conventional CLLC control device for a charger.

Referring to FIG. 6, the conventional control technique may be configured to control only one of voltage, current, and power according to each mode. The conventional control technique may not simultaneously control the output power and output voltage or the output power and output current between each module. Accordingly, it may not be possible to perform voltage adjustment required for battery charging along with the control to reduce circulating current by adjusting the output current of each module to be the same.

The present disclosure may relate to a charger control device, to which the circulating current reduction control technique is applied, in order to improve the disadvantages of the conventional control technique.

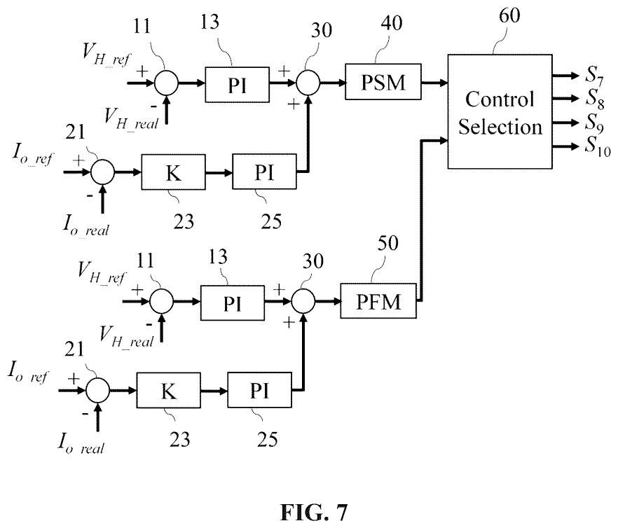

FIG. 7 is a view for explaining a charging device for reducing circulating currents according to an exemplary embodiment.

Referring to FIG. 7, the charging device according to an exemplary embodiment may include a first PI controller 13, a second PI controller 25, a first operator 30, a PSM controller 40, a PFM controller 50, and a signal selector 60. In addition, the charging device may further include a voltage operator 11, a current operator 21, and a multiplier 23.

The voltage operator 11 may output an input related to a voltage. Specifically, the voltage operator 11 may calculate the difference between a reference voltage V_H_ref and an output voltage V_H_real. In this case, the output value of the voltage operator 11 may be the input related to the voltage and transmitted to the first PI controller 13.

The first PI controller 13 may receive an input related to a voltage. The first PI controller 13 may measure an output value of PI control, which is a proportional integral control, by using the received input. The first PI controller 13 may output data for PSM control or PFM control. The first PI controller 13 may transmit the output value to the first operator 30.

The current operator 21 may output an input related to a current. Specifically, the current operator 21 may calculate the difference between a reference current I_o_ref and an output current I_o_real. In this case, the output value of the current operator 21 may be the input related to the current and transmitted to the second PI controller 25.

The charging device may further include a multiplier 23. The multiplier 23 may be connected right before the first PI controller 13 or the second PI controller 25. FIG. 7 may show an example in which the multiplier 23 is connected between the current operator 21 and the second PI controller 25, but it is not limited to this, and the multiplier 23 may be connected between the voltage operator 11 and the first PI controller 13.

The multiplier 23 may output K times the input. In this case, K may be a value between 0 and 1. The charging device may adjust the value of the voltage or the current by using the multiplier 23 such that the voltage or the current is within a range of the charging voltage or the charging current suitable for charging the battery. When the multiplier 23 is connected to the voltage operator 11, it may be understood that the charging device is operated entirely around the current. Alternatively, when the multiplier 23 is connected to the current operator 21, it may be understood that the charging device is operated entirely around the voltage.

The second PI controller 25 may receive the input related to the current. Alternatively, the second PI controller 25 may receive an output value of the multiplier 23. The second PI controller 25 may measure an output value of PI control, which is a proportional integral control, by using the received input. The second PI controller 25 may output data for the PSM control or the PFM control. The second PI controller 25 may transmit the output value to the first operator 30.

The first operator 30 may calculate the result value of the first PI controller 13 and the result value of the second PI controller 25. Specifically, the first operator 30 may perform an operation of adding the result value of the first PI controller 13 and the result value of the second PI controller 25. The first operator 30 may transmit the result value of the operation to the PSM controller 40 and/or the PFM controller 50.

The charging device of the present disclosure may follow a hybrid method that performs all PSM control and PFM control. However, it may be not limited thereto, and the control structure of the present disclosure may be applicable when performing only the PSM control or only the PFM control. For example, the operation signal of the switch may be output through performing only the PSM control or the PFM control by using the result values of the first PI controller 13 and the second PI controller 25.

Since the present disclosure uses a hybrid method, PSM control and PFM control may be switched depending on the case. For example, the control processor of the charging device may determine whether to perform the PSM control or the PFM control through a separate sensor. In addition, for example, the control processor of the charging device may be controlled to perform the PSM control in a step-down operation and the PFM operation in a step-up operation, but is not limited thereto.

The PSM controller 40 may output the switch operation signal according to the PSM control based on the result value of the first calculator 30. Specifically, the PSM controller 40 may control the output voltage by using the phase difference between the leading leg and the lagging leg of the primary-side switch or the secondary-side switch by using the result value of the first operator 30. In this case, the PSM controller 40 may output an operation signal of at least one switch included in the primary-side circuit of each converter module, but is not limited thereto.

The PFM controller 50 may output the switch operation signal according to the PFM control based on the result value of the first operator 30. Specifically, the PFM controller 50 may control the step-up and/or step-down section by adjusting the switching frequency by using the result value of the first operator 30. In this case, the PFM controller 50 may output an operation signal of at least one switch included in the primary-side circuit of each converter module, but is not limited thereto.

An output signal of the PSM controller 40 and/or an output signal of the PFM controller 50 may be transmitted to the signal selector 60. The signal selector 60 may output an operation signal of a switch using an output signal of the PSM controller 40 or an output signal of the PFM controller 50 depending on whether it is the PSM control or the PFM control. The control processor may change the on/off states of switches included in each converter module based on the output signal of the signal selector 60. In this case, the switch whose on/off state is changed by the signal selector 60 may be a primary-side circuit (the left circuit of the transformer) included in each converter module, but is not limited thereto.

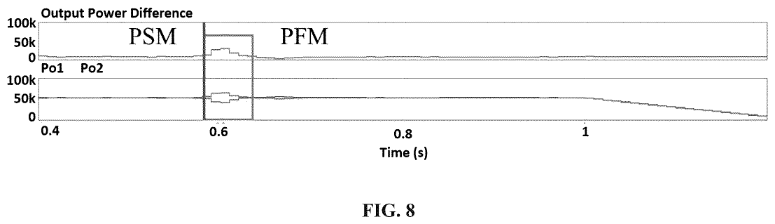

FIG. 8 is a graph showing an output waveform of each converter module in a control device according to an exemplary embodiment.

Referring to FIG. 8, the circulating currents may be identified during the PSM control and the PFM control. When comparing the graph of FIG. 8 with the graph of FIG. 5, it may be identified that the circulating currents are reduced by the control device according to an exemplary embodiment of the present disclosure. Like this, the charger control device according to an exemplary embodiment of the present disclosure may significantly reduce the circulating currents compared to the conventional one.

However, when the PI controller is separately included in the PSM controller 40 and the PFM controller 50 as in the control device of FIG. 7, there may occur a problem that only one of the two PI controllers can perform the control of adjusting the output voltage. For example, when operating with the PSM control, the first PI controller 13 connected to the PSM controller 40 can normally output the duty for adjusting the output voltage and output current. However, since the second PI controller 25 connected to the PFM controller 50 adjusts the output voltage and output current by the first PI controller 13 connected to the PSM controller 40, there may occur a problem that the operation switching frequency for adjusting the output voltage and output current cannot be normally outputted.

That is, since the second PI controller 25 connected to the PFM controller 50 may not operate normally until just before the control is switched, an output voltage and an output current may fluctuate in the transitional section where the control is switched, and the circulating currents may temporarily occur. To solve this problem, a charging device according to another exemplary embodiment of the present disclosure may be used.

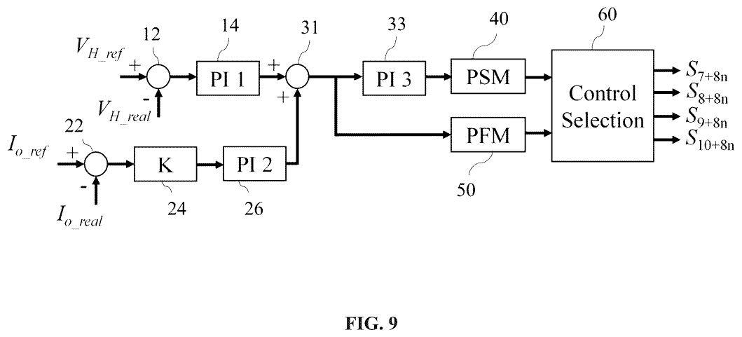

FIG. 9 is a view for explaining a charging device for reducing circulating currents according to another exemplary embodiment.

Referring to FIG. 9, the charging device according to another exemplary embodiment may include a first PI controller 14, a second PI controller 26, a first operator 31, a third PI controller 33, a PSM controller 40, a PFM controller 50, and a signal selector 60. In addition, the charging device may further include a voltage operator 12, a current operator 22, and a multiplier 24.

The charging device of FIG. 9 may further include a third PI controller 33 compared to the charging device of FIG. 7. In addition, the charging device of FIG. 9 may have a different connection relationship between each component from that of the charging device of FIG. 7. However, the functions of the first PI controller 14, the second PI controller 26, the first operator 31, the voltage operator 12, the current operator 22, the multiplier 24, the PSM controller 40, the PFM controller 50, and the signal selector 60 of FIG. 9 may be respectively the same as those of the first PI controller 13, the second PI controller 25, the first operator 30, the voltage operator 11, the current operator 21, the multiplier 23, the PSM controller 40, the PFM controller 50, and the signal selector 60 of FIG. 7, and therefore, duplicated content may be omitted.

The voltage operator 12 may output an input related to a voltage by using a reference voltage and an output voltage as inputs and transmit the same to the first PI controller 14. The first PI controller 14 may transmit a result value according to PI control to the first operator 31 based on the inputted value.

The current operator 22 may output an input related to a current by using a reference current and an output current as inputs and transmit the same to the second PI controller 26. In this case, the multiplier 24 may be connected between the current operator 22 and the second PI controller 26 such that a value being K times the output value of the current operator 22 may be inputted to the second PI controller 26. The second PI controller 26 may transmit the result value according to the PI control to the first operator 31 based on the inputted value.

The first operator 31 may calculate the result value of the first PI controller 14 and the result value of the second PI controller 26. Specifically, the first operator 31 may perform an operation of adding the result value of the first PI controller 14 and the result value of the second PI controller 26. The first operator 31 may transmit the output value to the third PI controller 33 and the PFM controller 50.

According to an exemplary embodiment, when generating an output value related to frequency, the first operator 31 may need the third PI controller 33 in order to generate an input of the PSM controller 40 related to a duty. Specifically, the third PI controller 33 may convert the output value of the first operator 31 related to the frequency into a value related to the duty. Accordingly, the output value of the third PI controller 33 may be transmitted to the PSM controller 40, and the PSM controller 40 may output a value for PSM control based on the inputted value.

According to another exemplary embodiment, when generating an output value related to the duty, the first operator 31 may need the third PI controller 33 in order to generate an input of the PFM controller 50 related to the frequency. In this case, the third PI controller 33 may be connected to an input terminal of the PFM controller 50, unlike as shown in FIG. 9. Specifically, the third PI controller 33 may convert the output value of the first operator 31 related to the duty into a value related to the frequency. Accordingly, the output value of the third PI controller 33 may be transmitted to the PFM controller 50, and the PFM controller 50 may output a value for the PFM control based on the inputted value.

The charger control device according to the exemplary embodiment of FIG. 9 may simultaneously perform the charging operation and the circulating current reduction by adjusting simultaneously the output voltage and the output current of each individual converter module to be the same through the first PI controller 14 and the second PI controller 26. The charger control device of FIG. 9 may perform circulating current reduction even in a transient section where the control technique is switched by controlling the output voltage and output current through the same PI controller (the third PI controller) for both control techniques.

As a result, throughout the entire electric vehicle charging section, the present disclosure may minimize circulating currents generated by errors between element parameters, errors between switching signals, and transient sections where control techniques are switched.

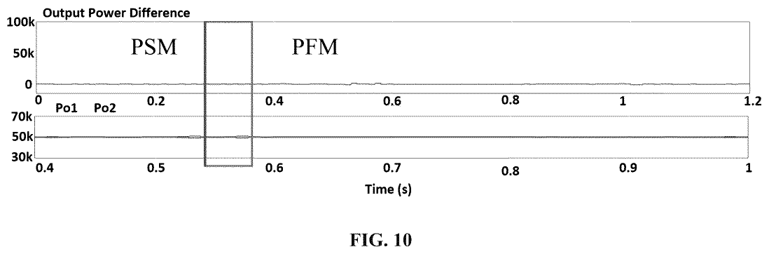

FIG. 10 is a graph showing an output waveform of each converter module in a control device according to another exemplary embodiment.

Referring to FIG. 10, the circulating currents may be identified during the PSM control and the PFM control. When comparing the graph of FIG. 10 with the graph of FIG. 8, it may be identified that the circulating currents are minimized even in the transient section where the PSM control is switched to the PFM control by applying the structure of FIG. 9. Accordingly, although circulating currents are reduced when the structure of FIG. 7 is applied, the present disclosure may reduce the circulating currents even in the transient section where the control is switched by applying the structure of FIG. 9.

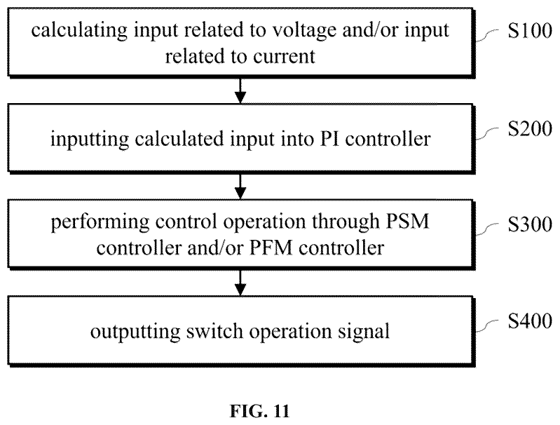

FIG. 11 is a view showing a flowchart of a charger control method according to an exemplary embodiment.

Referring to FIG. 11, the charger control method according to an exemplary embodiment may include S100 calculating an input related to a voltage and/or an input related to a current, S200 inputting the calculated input into a PI controller, S300 performing a control operation through a PSM controller and/or a PFM controller, and S400 outputting a switch operation signal. FIG. 11 may show that steps S100 to S400 are performed sequentially, but the present disclosure may not be limited thereto, and new steps may be added or some steps may be merged and performed simultaneously.

The calculating the input related to the voltage and/or the input related to the current S100 may be a step in which the voltage operators 11, 12 and/or the current operators 21, 22 calculate the input related to the voltage and/or the input related to the current by using a reference voltage, a reference current, an output voltage and/or an output current.

The inputting the calculated input to the PI controller S200 may be a step in which the result values of the voltage operators 11, 12 and the current operators 21, 22 are inputted to the first PI controllers 13, 14 and the second PI controllers 25, 26. In this case, this may further include a process in which the input related to the voltage or the input related to the current is multiplied by K by the multiplier 23, 24. In addition, subsequently the result values of the first PI controllers 13, 14 and the second PI controllers 25, 26 may be added by the first operators 30, 31.

The S300 performing the control operation through the PSM controller and/or the PFM controller may be a step in which the control operation is performed via the PSM controller 40 and/or the PFM controller 50 based on the result value of the first operators 30, 31. In this case, the PSM controller 40 and/or the PFM controller 50 may output a signal for controlling the on/off of the switch.

The outputting the switch operation signal S400 may be a step of outputting the switch operation signal that changes the on/off of the switch included in each converter module by using the PSM controller 40, the PFM controller 50, and/or the signal selector 60. In this case, the switch receiving the switch operation signal may be at least one switch included in the primary-side circuit of each converter module, but is not limited thereto.

The method according to an exemplary embodiment may be implemented in the form of program instructions that are executed through various computer means and may be recorded on a computer-readable medium. The computer-readable medium may include program instructions, data files, data structures, and the like alone or in combination. Program instructions recorded on the medium may be specially designed and configured for exemplary embodiments, or may be those known to and available to those skilled in the art of computer software. Examples of computer-readable recording media may include magnetic media such as hard disks, floppy disks and magnetic tapes, optical media such as CD-ROMs and DVDs, magneto-optical media such as floptical disks, and hardware devices specifically configured to store and execute program instructions, such as ROMs, RAMs, and flash memories.

Examples of program instructions may include not only machine language codes, such as that made by a compiler, but also high-level language codes that may be executed by a computer using an interpreter and the like. The hardware device described above may be configured to operate as one or more software modules in order to perform the operations of the exemplary embodiments, and vice versa.

Although the exemplary embodiments have been described by limited exemplary embodiments and drawings as described above, those skilled in the art may make various modifications and variations from the above description. For example, appropriate results may be achieved even when the described techniques are performed in a different order from the described method, and/or the components of the described system, structure, device, circuit, and the like are combined or joined in a different form from the described method, or are replaced or substituted by other components or equivalents.

Therefore, other implementations, other exemplary embodiments, and those equivalent to the claims may fall within the scope of the claims described below.

What is claimed is:

1. A charger control device, the device comprising:
a first PI controller receiving an input related to a voltage;
a second PI controller receiving an input related to a current;
a first operator calculating a result value of the first PI controller and a result value of the second PI controller;
a PSM controller outputting a switch operation signal according to a PSM control based on the result value of the first operator; and
a PFM controller outputting a switch operation signal according to a PFM control based on the result value of the first operator.

2. The device of claim 1, further comprising:
a voltage operator outputting the input related to the voltage,
wherein the voltage operator calculates a difference between a reference voltage and an output voltage.

3. The device of claim 1, further comprising:
a current operator outputting the input related to the current,
wherein the current operator calculates a difference between a reference current and an output current.

4. The device of claim 1, wherein the first PI controller is connected to a multiplier receives K times the input related to the voltage from the multiplier, or
the second PI controller is connected to the multiplier and receives K times the input related to the current,
wherein K is a value between 0 and 1.

5. The device of claim 1, further comprising:
a third PI controller receiving the result value of the first operator,
wherein the PFM controller performs the PFM control by using the result value of the first operator as an input, and
the PSM controller performs the PSM control by using a result value of the third PI controller as an input.

6. The device of claim 1, wherein the PSM controller and the PFM controller output an operation signal of at least one switch included in a primary-side circuit of a converter module.

7. A charging device, comprising:
at least one parallel module being composed of an AC/DC converter module and a DC/DC converter module; and
a control device controlling the at least one parallel module,
wherein the control device comprises:
a first PI controller receiving an input related to a voltage;
a second PI controller receiving an input related to a current;
a first operator calculating a result value of the first PI controller and a result value of the second PI controller;
a PSM controller outputting a switch operation signal according to a PSM control based on the result value of the first operator; and
a PFM controller outputting a switch operation signal according to a PFM control based on the result value of the first operator.

8. The device of claim 7, wherein the PSM controller and the PFM controller output an operation signal of at least one switch included in a primary-side circuit of the DC/DC converter module.

9. A charger control method performed in at least one processor, the method comprising:
calculating an input related to a voltage by using a difference between a reference voltage and an output voltage;
calculating an input related to a current by using a difference between a reference current and an output current;
inputting the input related to the voltage into a first PI controller as well as inputting the input related to the current to a second PI controller;
calculating a PI control result value by using a result value of the first PI controller and a result value of the second PI controller; and
outputting a PSM control or a switch operation signal according to the PSM control based on the PI control result value.
